(19) United States
(12) Patent Application Publication
(10) Pub. No.: US 2017/0046188 A1
(43) Pub. Date: Feb. 16, 2017

(54) PLACING VIRTUAL MACHINES ON PHYSICAL HARDWARE TO GUARANTEE BANDWIDTH

(71) Applicant: HEWLETT PACKARD ENTERPRISE DEVELOPMENT LP, Houston, TX (US)

(72) Inventors: Jung Gun LEE, Mountain View, CA (US); Yoshio TURNER, San Francisco, CA (US); Sujata BANERJEE, Palo Alto, CA (US)

(21) Appl. No.: 15/306,165

(22) PCT Filed: Apr. 24, 2014
(86) PCT No.: PCT/US2014/035262

§ 371 Date: Oct. 24, 2016

(51) Int. Cl. G06F 9/455; H04L 12/911; H04L 12/64

(52) U.S. Cl. CPC G06F 9/45558; H04L 12/6418; H04L 47/70; G06F 2009/4557; G06F 2009/45595

(57) ABSTRACT

Placing virtual machines (VMs) on physical hardware to guarantee bandwidth includes obtaining a Tenant Application Graph (TAG) model, the TAG model representing a network abstraction model based on an application communication structure between VMs of components, determining bandwidths for the components based on the TAG model, and placing the VMs of the components on physical hardware based on the bandwidths for the components.

### BACKGROUND

Virtualized Network services have grown immensely in popularity. Users may be provided with access to applications and data storage on the network without having to worry about the infrastructure and platforms that run the user's applications and store the user's data. In some cases, users, such as tenants, may negotiate with the network service provider to guarantee certain performance of their applications so they can operate with the desired level of service.

### BRIEF DESCRIPTION OF THE DRAWINGS

The accompanying drawings illustrate various examples of the principles described herein and are a part of the specification. The examples do not limit the scope of the claims.

FIG. 1 is a diagram of an example of a system for placing virtual machines (VMs) on physical hardware to guarantee bandwidth, according to one example of principles described herein.

FIG. 2 is a diagram of an example of a Tenant Application Graph (TAG) model, according to one example of principles described herein.

FIG. 3 is a diagram of an example of a detailed illustration of the TAG from FIG. 2, according to one example of principles described herein

FIG. 4 is a diagram of an example of a TAG model with three components, according to one example of principles described herein.

FIG. 5 is a diagram of an example of physical hardware for placing VMs, according to one example of principles described herein.

FIG. 6 is a diagram of an example of a system for placing VMs on physical hardware to guarantee bandwidth, according to one example of principles described herein

FIG. 7 is a flowchart of an example of a method for placing VMs on physical hardware to guarantee bandwidth, according to one example of principles described herein.

FIG. 8 is a flowchart of an example of a method for placing VMs on physical hardware to guarantee bandwidth, according to one example of principles described herein.

FIG. 9 is a diagram of an example of a placing system, according to one example of principles described herein.

FIG. 10 is a diagram of an example of a placing system, according to one example of principles described herein.

Throughout the drawings, identical reference numbers designate similar, but not necessarily identical, elements.

### DETAILED DESCRIPTION

Understanding communication patterns of users using an application is essential to provision network services for the users. By provisioning the network services for the users, the network services meet the application criteria while efficiently managing the network resources.

Often, network service providers do not offer guarantees for the network bandwidth in network datacenters or enterprise networks. As a result, this prevents the users from running their applications predictably. Since many applications have stringent network criteria, network service providers that host these applications tend to overprovision network bandwidth to satisfy application criteria by configuring each tenant's network individually. Further, public network service providers offer very little network performance predictability for a specific tenant. As a result, network resources, such as bandwidth, are not efficiently managed.

The principles described herein include a method for placing virtual machines (VMs) on physical hardware to guarantee bandwidth. Such a method includes obtaining a Tenant Application Graph (TAG) model, the TAG model representing a network abstraction model based on an application communication structure between VMs of components, determining bandwidths for the components based on the TAG model, and placing the VMs of the components on physical hardware based on the bandwidths for the components. Such a method allows the TAG model to effectively model a component's bandwidth demands. As a result, network resources, such as bandwidth, and compute resources to be efficiently managed by placing VMs on appropriate physical hardware.

In the present specification and in the appended claims, the term “tenant application graph (TAG) model” is meant to be understood broadly as a model to describe bandwidth that is utilized by applications. The TAG model, for example, provides a way to describe the bandwidth utilized by an application and the described bandwidths may be reserved on physical links in a network to guarantee those bandwidths for the application. For example, bandwidth may be reserved for VM to VM communication such that the bandwidth meets the demand of VMs. In one example, the TAG model may model the actual communication patterns of an application, such as between components of an application, rather than modeling the topology of the underlying physical network which would have the same model for all the applications running on the network.

In the present specification and in the appended claims, the term “application” is meant to be understood broadly as a program executed for an end user, such as a tenant. In one example, an application may be an enterprise application. Further, an application may include a number of components.

In the present specification and in the appended claims, the term “component” is meant to be understood broadly as a function performed by an application. In one example, a component may be a tier, a webserver tier, or a business logic tier. Further, components may be executed on a number of VMs.

In the present specification and in the appended claims, the term “virtual machine” is meant to be understood broadly as a program running on physical hardware designed to emulate a specific set of hardware. In one example, several VMs may be placed on the physical hardware.

In the present specification and in the appended claims, the term “rate” is meant to be understood broadly as a measurement of speed at which bits of data are exchanged between VMs corresponding to, in often cases, two components within an application. In one example, the rate may be measured in megabits per second (Mbps). In another example, the rate may be measured in kilobits per second (Kbps). In yet another example, the rate may be measured in any appropriate unit.

Further, as used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

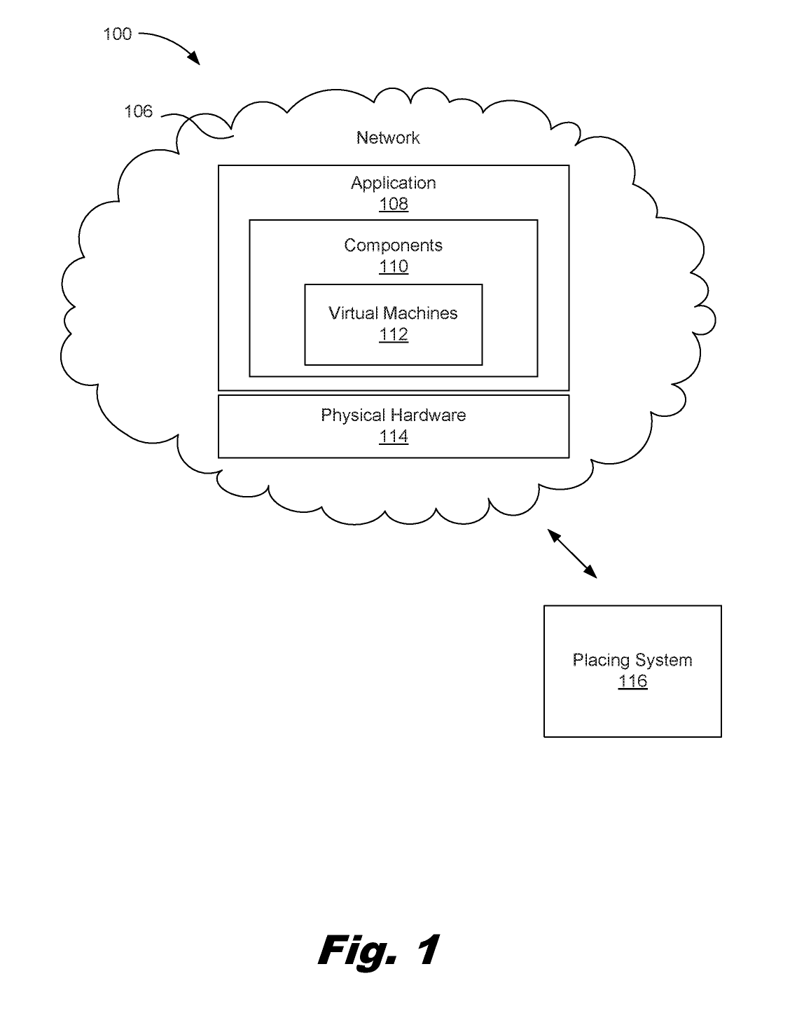

Referring now to the figures, FIG. 1 is a diagram of an example of a system for placing VMs on physical hardware to guarantee bandwidth, according to one example of principles described herein. As will be described below, a placing system is in communication with a network to obtain a TAG model, the TAG model representing a network abstraction model based on an application communication structure between VMs of components. Further, the placing system determines bandwidths for the components based on the TAG model. Further, the placing system places the VMs of the components on physical hardware based on the bandwidths for the components.

As illustrated, FIG. 1 includes a network (106). In one example, the network (106) may include physical hardware (114). In this example, the physical hardware (114) may include, among others, processors, memory and other storage devices, servers, and networking equipment including switches and routers. The physical hardware (114) performs the actual computing and networking and data storage. Further, the network (106) may be a tree-shaped physical data center topology.

As illustrated, the users or tenants run applications (108) in the network. The application (108) may be programs executed by end users or tenants. Further, the application (108) may be an enterprise application or any type of application or a service run by end users, enterprise ITs or network service providers. In one example, the network (106) may receive service requests from computers used by the end users or tenants and perform the desired processes, for example, by the application (108) and return results to the computers and other devices of the end users for example via the network (106). In one example, the tenants may be users who purchase VM instances and deploy their applications. End users may be users who send queries or client requests to a hosted application.

Further, the application (108) may include of multiple components (110). In one example, the components (110) are functions performed by an application (108). In one example, a component (110) is a tier, such as a database tier handling storage, a webserver tier handling web client requests, or a business logic tier executing a business application function. The size and bandwidth demands of the components (110) may vary over time. Further, the components (110) may include multiple instances of code executing the function or functions of the application (108). The multiple instances of the code may be hosted by the VMs (112). The components (110) may alternatively include a single instance of code performing the function of a component and running on a single VM. Each instance may have the same code base and multiple instances and VMs (112) may be used based on demand. By way of example, the components (110) may include multiple webserver instances in a webserver tier to accommodate requests from the end users.

As mentioned above, the components (110) may include a number of VMs (112). In one example, the VMs (112) are programs running on the physical hardware (114) and designed to emulate a specific set of hardware. In one example, several of the VMs (112) may be placed on the physical hardware (114). The VMs (112) may be hosted on servers that are located on different sub-trees in a physical network topology that has the shape of a tree. In one example, the sub-trees are optimized for network bandwidth guarantees, for example by minimizing the bandwidth guarantees for links that traverse the core switch in a tree-shaped physical network.

The system (100) further includes a placing system (116). As will be described in other parts of this specification, the placing system (116) obtains a TAG model, the TAG model representing a network abstraction model based on an application communication structure between VMs (112) of components (110). In one example, the TAG model models parts of the network (106) or the entire network (106).

Further, the placing system (116) determines bandwidths for the components (110) based on the TAG model. In one example, determining the bandwidths for the components based on the TAG model includes determining a sending bandwidth and a receiving bandwidth for each of the components (110).

The placing system (116) further places the VMs (112) of the components (110) on physical hardware (114) based on the bandwidths for the components. As a result, network resources, such as bandwidth, and compute resources to be efficiently managed by placing VMs on appropriate physical hardware (114). More information about the placing system (116) will be described in detail later on in this specification.

While this example has been described with reference to the placing system being located over the network, the placing system may be located in any appropriate location according to the principles described herein. For example, the placing system may be located in a user device, a server, a datacenter, an application, physical hardware, other locations, or combinations thereof.

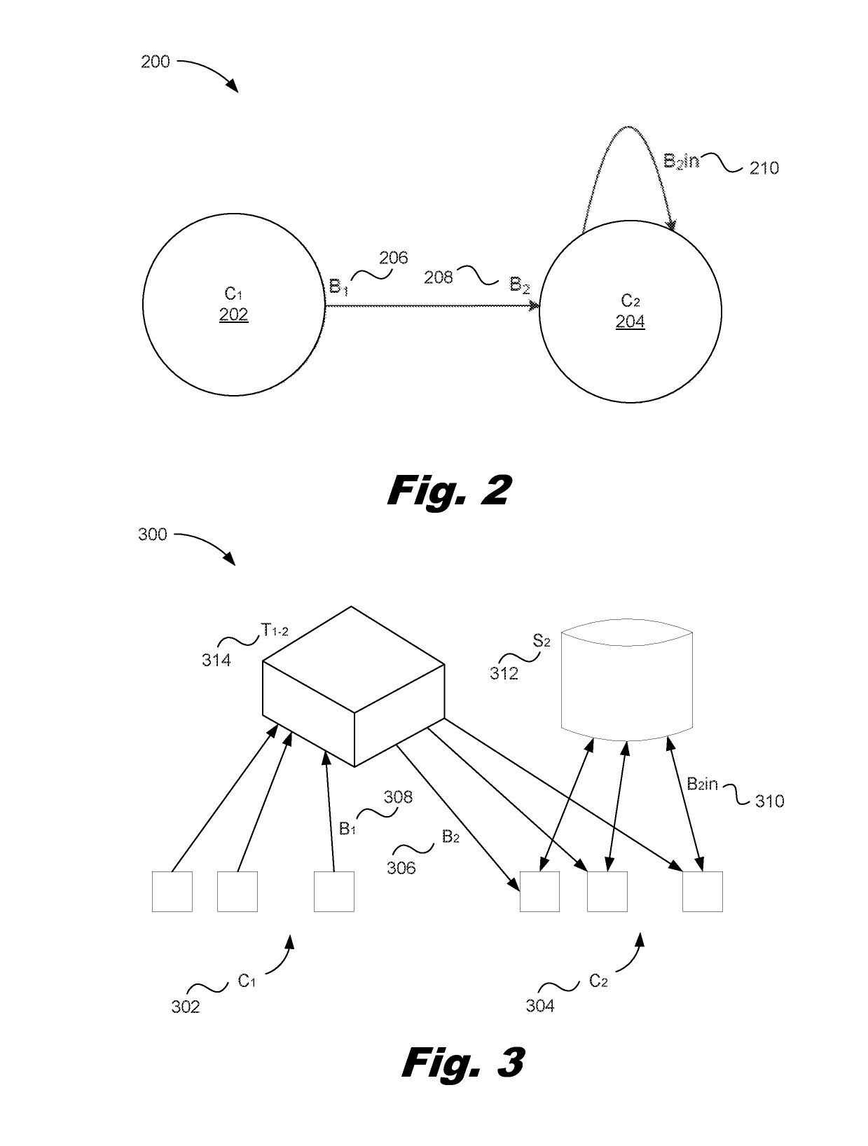

FIG. 2 is a diagram of an example of a TAG, according to one example of principles described herein. As illustrated in FIG. 2, the TAG (200) is an example of an application with two components C₁ (202) and C₂ (204). In this example, a directed edge from C₁ (202) to C₂ (204) is labeled B₁ (206) and B₂ (208). Thus, each VM in C₁ (202) is guaranteed to be able to send at rate (206) to the set of VMs in C₂ (204). Similarly, each VM in C₂ (204) is guaranteed to be able to receive at rate B₂ (208) from the set of VMs in C₁ (202). To guarantee the bandwidth, an application bandwidth modeling module models the application with a TAG and a placing engine determines placement of VMs according to the TAG and reserves bandwidth for the VMs on the links according to the bandwidth, such as B₁ (206) and B₂ (208). The TAG (200) has a self-edge, B₂ⁱⁿ (210) for component C₂ (204), describing the bandwidth guarantees for traffic where both source and destination are in C₂ (204).

FIG. 3 is a diagram of an example of a detailed illustration of the TAG from FIG. 2, according to one example of principles described herein. In one example, FIG. 3 illustrates an alternative way of visualizing the bandwidth expressed in FIG. 2. To model the bandwidth guarantees between C₁ (302) and C₂ (304), each VM in C₁ (302) is connected to a virtual trunk T₁₋₂ (314) by a dedicated directional link of capacity B₁ (308). Similarly, virtual trunk T₁₋₂ (314) is connected through a directional link of capacity B₂ (306) to each VM in C2 (304). The virtual trunk T₁₋₂ (314) represents directional transmission from C₁ (302) to C₂ (304) and may be realized in the physical network by one switch or a network of switches. For example, a virtual trunk is a conceptual model to present the directional, and often aggregate, bandwidth guarantees. If all of the VMs of C₁ (302) and C₂ (304) are hosted on the same server, the virtual trunk can be realized without involving any physical switch. The TAG (300) example in FIG. 3 has a self-edge for component C₂ (304), describing the bandwidth guarantees for traffic where both source and destination are in C₂ (304). The self-loop edge in FIG. 3 can be modeled by a virtual switch S₂, (312) to which each VM in C₂ (304) is connected to a bidirectional link of capacity B₂ⁱⁿ (310). In one example, a virtual switch may be a conceptual model. The virtual switch is different from a real software switch in the server's hypervisor that connects multiple VMs in the server. The virtual switch S₂ (312) represents bidirectional connectivity. S₂ (312) may be implemented by a network switch.

The TAG (300) is easy to use and moreover, since the bandwidth specified in the TAG (300) can be applied from any VM of one component to the VMs of another component, the TAG (300) accommodates dynamic load balancing between application components and dynamic re-sizing of application components, such as flexing or auto-scaling. The per-VM bandwidth Se and Re are not changed while component sizes change by flexing.

The TAG (300) can also accommodate middleboxes between the application components. Many types of middleboxes, such as load balancers and security services, examine the traffic in one direction, but not the reverse traffic (e.g., examine queries to database servers but not the replies from servers). The TAG (300) model can accommodate these unidirectional middleboxes as well.

Since queries often consume significantly less bandwidth than responses, the ability to specify directional bandwidths allows a TAG to deploy up to 2× more guarantees than a unidirectional model. For example, a VM with a high outgoing bandwidth can be located on the same server with a VM with a high incoming bandwidth. Users can identify the per-VM guarantees to use in the TAG (300) through measurements or compute them using the processing capacity of the VMs and a workload model.

TAG deployment which may be determined by a placing engine is now described. Deploying the TAG may include optimizing the placement of VMs on physical servers in the physical hardware while reserving the bandwidth on physical links in a network connecting the VMs. Then, bandwidth may be monitored to enforce the reserved bandwidths.

In one example, VMs are deployed in such a manner that as many VMs are deployed as possible on a tree-shaped physical topology while providing the bandwidth which may be specified by a tenant. The deployment may minimize the bandwidth usage in an oversubscribed network core, assumed to be the bottleneck resource for bandwidth in a tree-shaped network topology. The tree may include a root network switch, intermediate core switches (e.g., aggregation switches) and low-level switches below the core switches and connected to servers that are leaves in sub-trees (e.g., top of rack switches). The tree and sub-trees may include layer 3 and layer 2 switches. In one example, the smallest feasible sub-tree of the physical topology is selected for placement of VMs for a TAG. In the chosen sub-tree, the components that heavily talk to each other are placed under the same child node. Components that have bandwidth greater than a predetermined threshold may be considered heavy talkers. The threshold may be determined as a function of all the requested bandwidths. For example, the highest 20% may be considered “heavy talkers” or a threshold bandwidth amount may be determined from historical analysis of bandwidth demands. As will be described below, this may be done by the Colocate function. Further, the Colocate function may be implemented by leveraging or modifying existing methods, functions, or techniques. For example, the Colocate function may be implemented by leveraging or modifying an existing min-cut function. For example, the placement of these components is finding the minimum capacity cut in a directed network G with n nodes. For example, Hao and Orlin disclose a highly-cited minimum-cut function for solving the minimum-cut in Hao, Jianxiu; Orlin, James B. (1994). “A faster algorithm for finding the minimum cut in a directed graph”. J. Algorithms 17: 424-446. Other minimum-cut functions or other heuristics may be used.

Components that remain to be placed after the function is completed may try to consume core bandwidth independently of their placement in the sub-tree. To minimize core bandwidth consumption, the VMs of these remaining components may be placed in a manner that maximizes server consolidation by fully utilizing both link bandwidth and other resources (CPU, memory, etc.) of individual servers. This may be accomplished by solving the problem as the well-known subset-sum problem. Several functions are available to solve the subset-sum problem. One example is disclosed by Vincent Poirriez, Nicola Yanev, Rumen Andonov (2009), “A Hybrid Algorithm for the Unbounded Knapsack Problem Discrete Optimization.” In one example, for the components that remain that do not communicate much with each other (e.g., have no directed edge between each other or have a directed edge with a bandwidth less than a threshold) may be placed together if one component has a high bandwidth with other components and the other component has a low bandwidth with other components. Once component placement is determined, bandwidth may be reserved on the physical links for the components for example based on traffic distribution between VMs in a component.

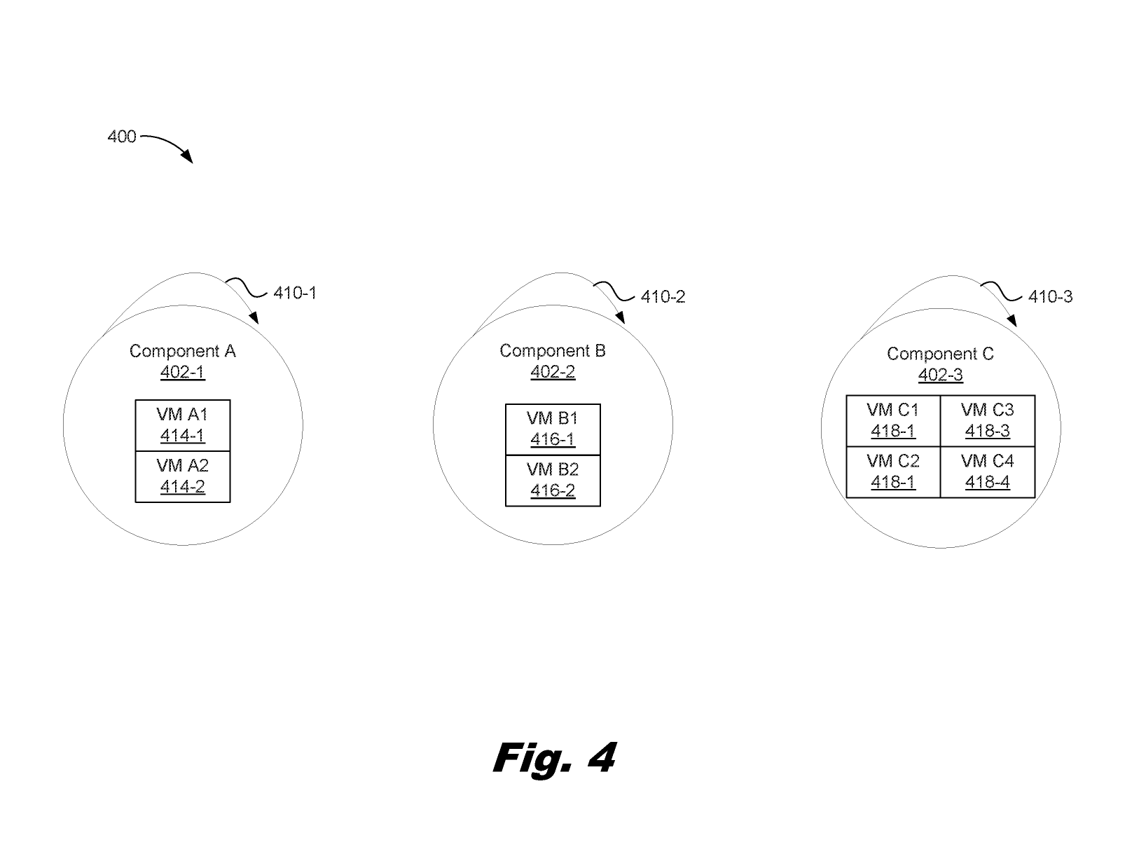

FIG. 4 is a diagram of an example of a TAG model with three components, according to one example of principles described herein. As mentioned above, a TAG model represents a network abstraction model based on an application communication structure between VMs of components. In one example, the TAG model models parts of the network or the entire network.

As illustrated in FIG. 4, the TAG model (400) includes three components (402). For example, component A (402-1), component B (402-2), and component C (402-3). In one example, the components (402) are functions performed by an application. In one example, a component is a tier, such as a database tier handling storage, a webserver tier handling requests, or a business logic tier executing a business application function. The size and bandwidth demands of the components may vary over time. Further, the components (402) may include multiple instances of code executing the function or functions of the application. The multiple instances the code may be hosted by VMs (414, 416, 418). The components (402) may alternatively include a single instance of code performing the function of a component and running on a single VM. Each instance may have the same code base and multiple instances and VMs (414, 416, 418) may be used based on demand. By way of example, the components (402) may include multiple webserver instances in a webserver tier to accommodate requests from the end users.

As mentioned above, the components (402) may include a number of VMs (414, 416, 418). As illustrated in FIG. 4, component A (402-1) includes VM A1 (414-1) and VM A2 (414-2). Component B (402-2) includes VM B1 (416-1) and VM B2 (416-2). Component C (402-3) includes VM C1 (418-1), VM C2 (418-2), VM C3 (418-3), and VM C4 (418-4).

In one example, the VMs (414, 416, 418) are programs running on the physical hardware and designed to emulate a specific set of hardware. In one example, several of the VMs (414, 416, 418) may be placed on the physical hardware. The VMs (414, 416, 418) may be hosted on servers that are located on different sub-trees in a physical network topology that has the shape of a tree. In one example, the sub-trees are optimized for network bandwidth guarantees, for example by minimizing the bandwidth guarantees for links that traverse the core switch in a tree-shaped physical network.

To guarantee the bandwidth, an application bandwidth modeling module models the application with the TAG model (400) and a placing engine determines placement of VMs according to the TAG model (400) and reserves bandwidth for the VMs (414, 416, 418) on the links according to the bandwidth. As illustrated, the TAG model (400) has a self-edge 410-1 for component A (402-1), describing the bandwidth guarantees for traffic where both source and destination are in component A (402-1). Similarly, the TAG model (400) has a self-edge 410-2 for component B (402-2), describing the bandwidth guarantees for traffic where both source and destination are in component B (402-2). Further, the TAG model (400) has a self-edge 410-3 for component C (402-3), describing the bandwidth guarantees for traffic where both source and destination are in component C (402-3).

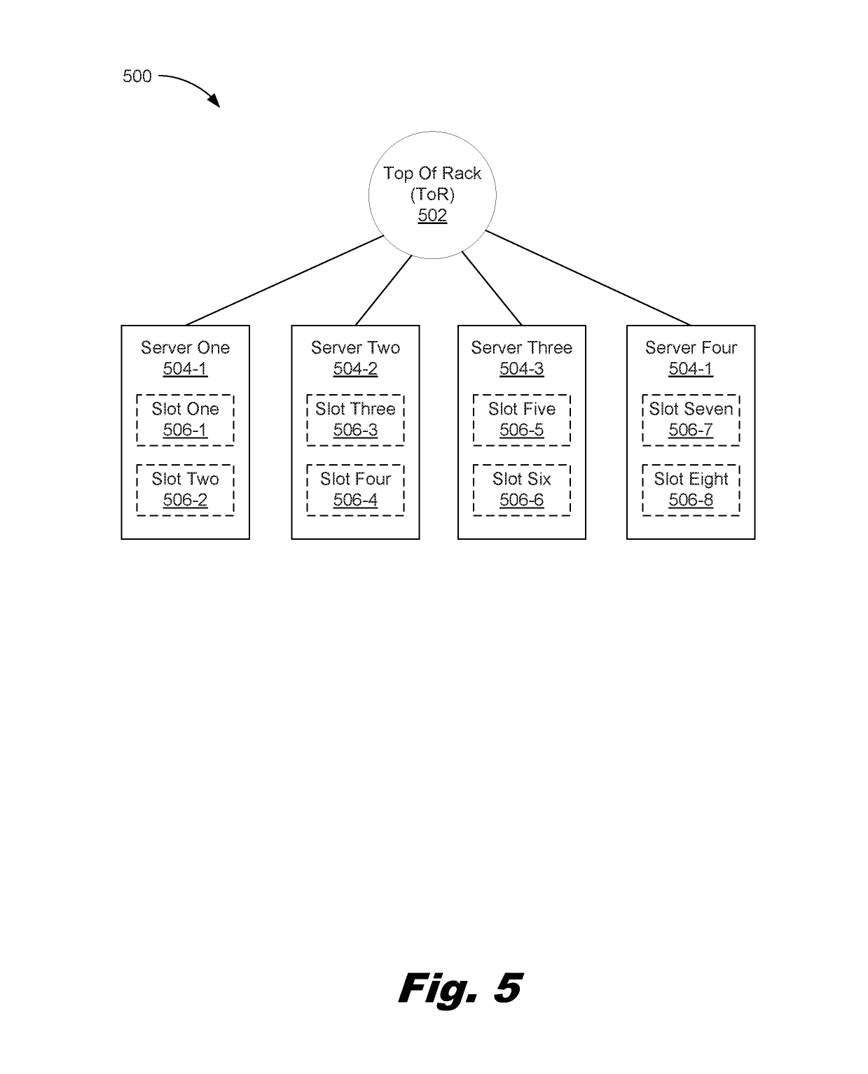

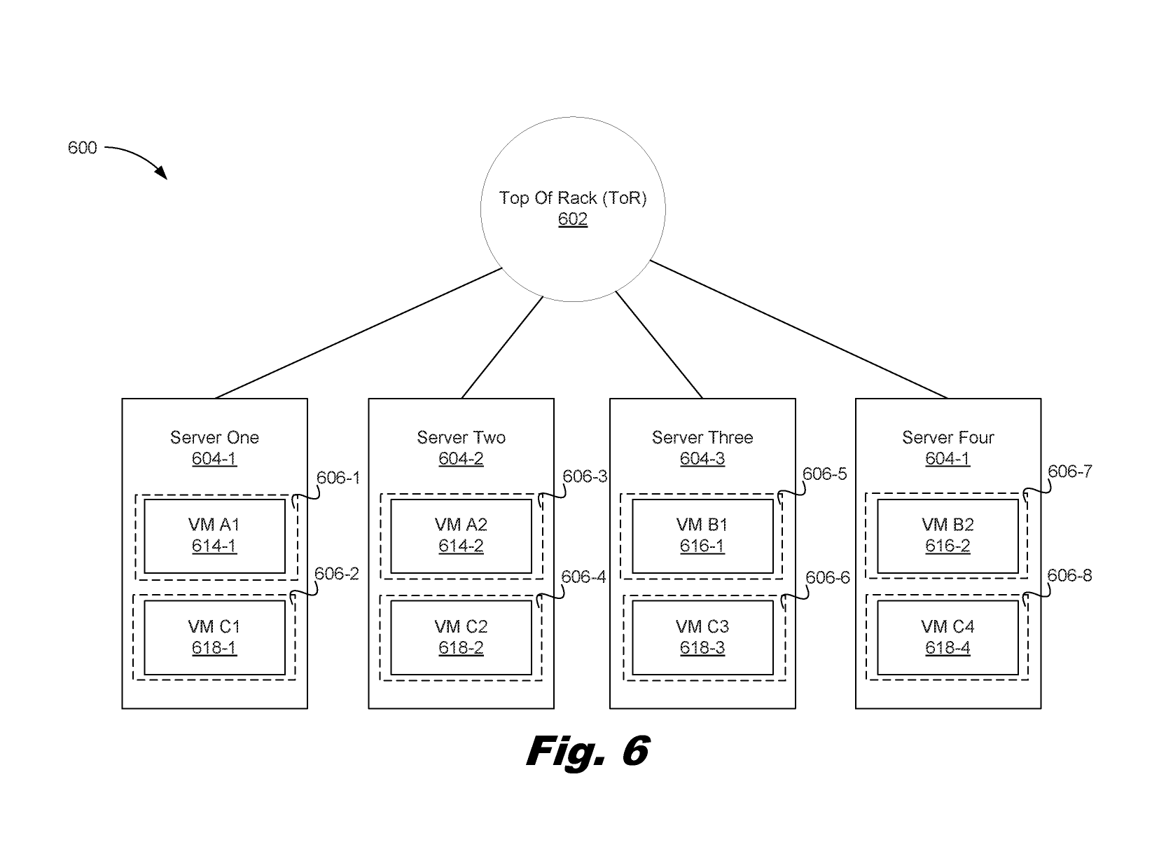

As will be described in other parts of this specification, this TAG model (400) will be used as an example for placing VMs on physical hardware to guarantee bandwidth. This will be described using FIGS. 5 and 6.

While this example has been described with reference to the TAG model including self-edges for each of the components, the TAG model may include direct edges. As mentioned above, the direct edges define a sending rate or a receiving rate for communication between components.

FIG. 5 is a diagram of an example of physical hardware for placing VMs, according to one example of principles described herein. As mentioned above, a network may include physical hardware. In one example, the physical hardware may include, among others, processors, memory and other storage devices, servers, and networking equipment including switches and routers. The physical hardware performs the actual computing and networking and data storage.

As illustrated in FIG. 5, the physical hardware (500) may include a top of rack (ToR) (502). In one example, the ToR (502) may be a small port count switch that is positioned on top of a rack in a data center. Further, the physical hardware (500) may include a number of servers (504). As illustrated, the physical hardware (500) includes four servers (504) namely server one (504-1), server two (504-2), sever three (504-3), and server four (504-4). Each of the servers (504) may include a number of slots (506). For example, sever one (504-1) includes slot one (506-1) and slot two (506-3). Server two (504-2) includes slot three (506-3) and slot four (506-4). Server three (504-3) includes slot five (506-5) and slot six (506-6). Server four (504-4) includes slot seven (506-7) and slot eight (506-8).

In one example, VMs may be placed in the slots (506) by the placing system of FIG. 1. Placing VMs in the slots (506) will be described in FIG. 6.

While this example has been described with reference to the physical hardware including a ToR, four servers, and two slots per server, the physical hardware may include several ToRs, several servers, several slots per server, other hardware, or combinations thereof. For example, the physical hardware may include ten ToRs, twenty servers per ToR, and sixteen slots per server.

FIG. 6 is a diagram of an example of a system for placing VMs on physical hardware to guarantee bandwidth, according to one example of principles described herein. As mentioned above, a placing system is in communication with a network to obtain a TAG model, the TAG model representing a network abstraction model based on an application communication structure between VMs of components. Further, the placing system determines bandwidths for the components based on the TAG model. Further, the placing system places the VMs of the components on physical hardware based on the bandwidths for the components.

In one example, the placing system of FIG. 1 may obtain the TAG model of FIG. 4. As mentioned in FIG. 4, the TAG model includes component A, component B, and component C. Component A includes VM A1 and VM A2. Component B includes VM B1 and VM B2. Component C includes VM C1, VM C2, VM C3, and VM C4.

As mentioned above, the placing system of FIG. 1 determines bandwidths for the components based on the TAG model. As mentioned in FIG. 4, the TAG model (400) has a self-edge 410-1 for component A, describing the bandwidth guarantees for traffic where both source and destination are in component A. The TAG model (400) has a self-edge for component B, describing the bandwidth guarantees for traffic where both source and destination are in component B. Further, the TAG model has a self-edge 410-3 for component C, describing the bandwidth guarantees for traffic where both source and destination are in component C.

As mentioned above, the placing system places the VMs (614, 616, 618) of the components on physical hardware (600) based on the bandwidths for the components. In one example, a placing system places the VMs (614, 616, 618) of the components on physical hardware based (600) on the bandwidths for the components. In one example, the placing system places the VMs (614, 616, 618) of the components on the physical hardware (600) based on the bandwidths for the components by, generating, from the TAG model, a list of components, communication edges of the components, attributes of the components, or combinations thereof, localizing communication patterns between the VMs (614, 616, 618) of the components defined in the TAG model, and mapping locations where the VMs (614, 616, 618) are to be allocated on the physical hardware (600) and bandwidths of the VMs (614, 616, 618).

In one example, mapping the locations where the VMs (614, 616, 618) are to be allocated on the physical hardware (600) and the bandwidths of the VMs (614, 616, 618) includes performing a Colocate function, a Balance function, or combinations thereof. In one example, the Colocate function groups the VMs (614, 616, 618) close together on the physical hardware (600) to reduce traffic between the VMs (614, 616, 618) for bandwidth saving. Further, the Balance function determines utilization of compute resources, network resources, or combinations thereof. As a result, the main goals of the Colocate function and the Balance function are to determine the sets of VMs to place on physical hardware based on each respective optimization goals. As a result, these functions reduce bandwidth consumption and balance resource utilization. Further, the placing system places the VMs (614, 616, 618) of the components on the physical hardware (600) based on the bandwidths for the components to provide high availability (HA) and predictable performance for communication patterns for the VMs.

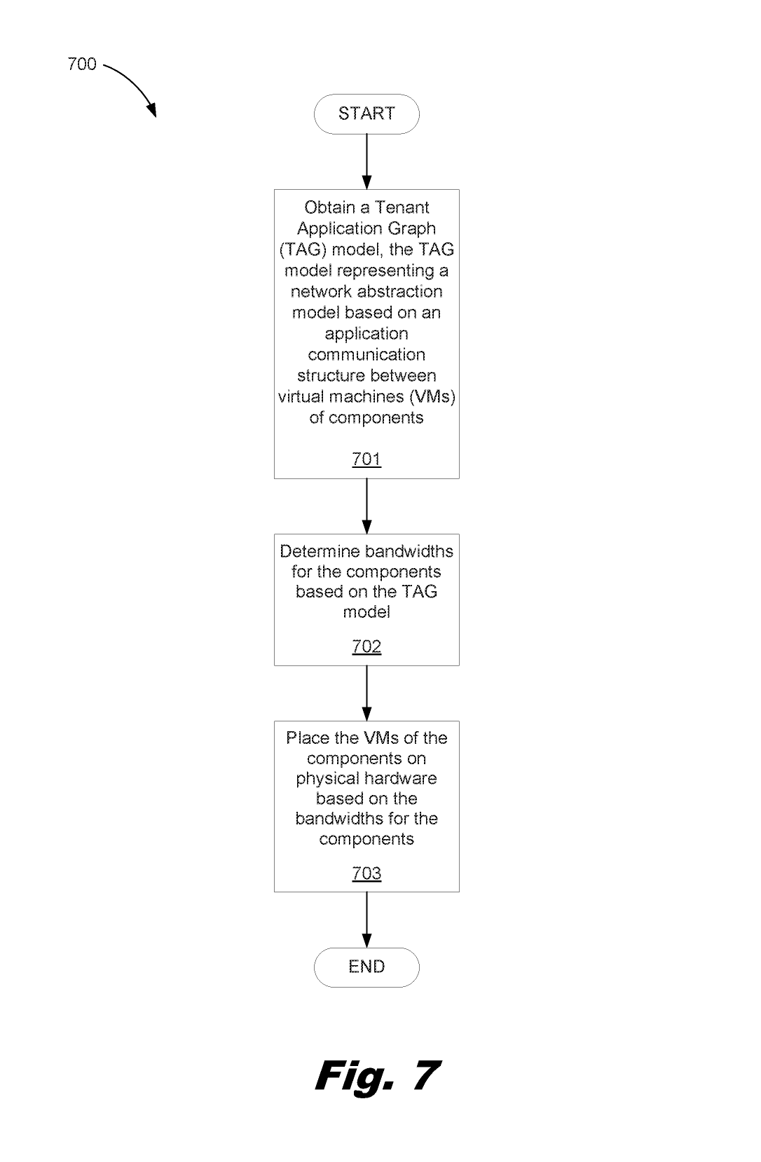

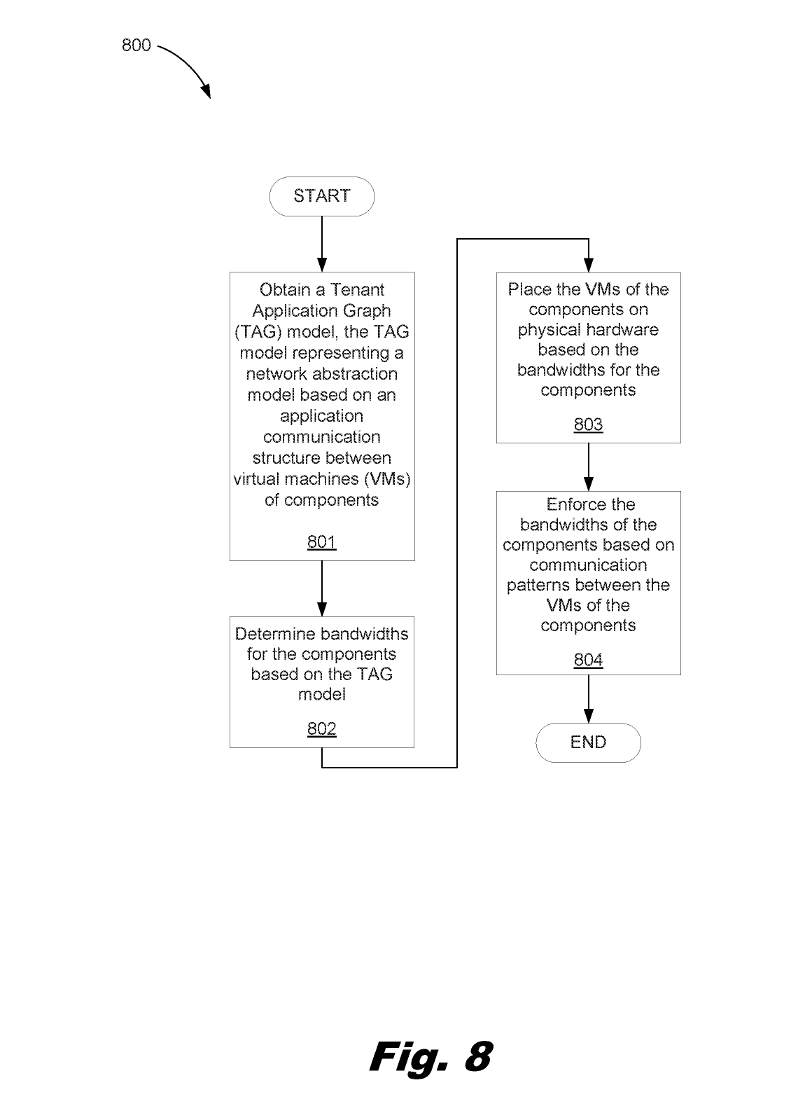

As illustrated, the placing system places VM A1 (614-1) in slot one (606-1) on sever one (604-1) and VM C1 (618-1) in slot two (606-2) on server one (604-2). The placing system places VM A2 (614-2) in slot three (606-3) on sever two (604-2) and VM C2 (618-2) in slot four (606-4) on server two (604-2). The placing system places VM B1 (616-1) in slot five (606-5) on sever three (604-3) and VM C3 (618-3) in slot six (606-6) on server three (604-3). The placing system places VM B2 (616-2) in slot seven (606-7) on sever three (604-3) and VM C4 (618-4) in slot eight (606-8) on server three (604-3). More information about the method of the placing system will be described in FIGS. 7 and 8.

FIG. 7 is a flowchart of an example of a method for placing VMs on physical hardware to guarantee bandwidth, according to one example of principles described herein. In one example, the method (700) may be executed by the system (100) of FIG. 1. In other examples, the method (700) may be executed by other systems such as system 900 or system 1000. In this example, the method (700) includes obtaining (701) a TAG model, the TAG model representing a network abstraction model based on an application communication structure between VMs of components, determining (702) bandwidths for the components based on the TAG model, and placing (703) the VMs of the components on physical hardware based on the bandwidths for the components.

As mentioned above, the method (700) includes obtaining (701) a TAG model, the TAG model representing a network abstraction model based on an application communication structure between virtual machines (VMs) of components. In one example, the TAG model may be created by obtaining a traffic matrix. In this example, the traffic matrix defines a rate for which bits of data are exchanged between VMs corresponding to an application. In one example, a traffic matrix may be created by a number of standard network measurement functions. In this example, a standard network measurement function such as sFlow packet sampling may be used to create a traffic matrix. In another example, a standard network measurement function such as netflow may be used to create a traffic matrix. In one example, the VMs of the traffic matrix are identified by their internet protocol (IP) address. In one example, if there are three VMs, the VM-level traffic matrix is a 3×3 matrix. In yet another example, if there are five VMs, the VM-level traffic matrix is a 5×5 matrix.

Further, each entry in the traffic matrix is a rate for which packets of data are exchanged between VMs corresponding to an application. In one example, the rate may be an average rate over a specific amount of time. In another example, the rate may be a peak rate measured over a specific amount of time. In yet another example, the rate may be an x-th percentile of the average or peak rate.

While this example has been described in reference to obtaining a traffic matrix defining a rate for which packets of data are exchanged between VMs corresponding to an application, the method may be utilized for non-virtualized systems.

As mentioned above, the components may be executed on a number of VMs. In one example, a method analyzes the traffic matrix to identify the VMs within the component includes determining a structure of the component and communication patterns of the component. Some users understand the structure of the applications that they deploy in the network and are willing to share this information with the network service provider. Those users can use the TAG model specification to describe their application structure. In another example, a way to learn about users' application structure is in the case when users or tenants compose their applications by using network orchestration systems, such as OpenStack, HEAT, and AWS CloudFormation. These network orchestration systems provide application templates for users to start from. The VMs created from the same template naturally form a component in the TAG.

Alternatively, there are some users or tenants who do not have information about their application structure or choose not to specify it for the network service provider. In these cases, the method infers the structure and communication of the application. In some cases several or all components are identified by the user or tenant. In this case the method starts from the given components and automatically identifies any other components not specified by the user or tenant.

The TAG model may be created by further creating a modified traffic matrix based on the traffic matrix. As will be described below, the traffic matrix can be modified using many techniques. Further, the techniques used to modify the traffic matrix may also be used to define a TAG model. Further, the modified traffic matrix is used to define a TAG model. As a result, more information about the modified traffic matrix will be described below.

Further, a TAG model is then created based on the modified traffic matrix. In one example, defining, for the application, a TAG model based on the modified traffic matrix includes applying a hose identification method on the traffic matrix to create a number of cliques to define the TAG model. In one example, applying the hose identification method to the traffic matrix to create a number of cliques to define the TAG model includes, identifying, based on the traffic matrix, groups of VMs. In one example, the method identifies all pairs of VMs in the group of VMs that communicate with each other. In one example, this communication pattern is represented by a hose model.

Further, the hose identification method applies a threshold parameter to the traffic matrix to create a threshold traffic matrix. The threshold parameter is used to determine if each entry in the traffic matrix is significant enough to be considered in inferring hose and/or trunk models. In one example, the default value for the threshold parameter is zero. Further, the threshold parameter may be changed at any time to accommodate a desired threshold parameter.

As mentioned above, applying the hose identification method to the traffic matrix to create a number of cliques to define the TAG model includes, identifying, based on the traffic matrix, groups of VMs. Group identification is accomplished by viewing the traffic matrix as a directed graph with weighted edges, and identifying cliques above the threshold parameter within the graph. This can be accomplished by constructing a symmetric adjacency matrix based on the threshold traffic matrix.

Further, the hose identification method cubes the symmetric adjacency matrix to create the modified traffic matrix. Rows of the resulting matrix that have non-zero entries on the diagonal correspond to VMs that belong to a clique of three or more VMs.

Further, modifying the identification method cubes identifies the number of cliques to define the TAG model. By considering all such cliques, and cliques consisting of just single VM pairs obvious from the original traffic matrix, the hose identification method groups VMs into components represented in a TAG graph as vertices, and constructs self-loop edges representing the hose models for these components.

Further, the hose identification method constructs virtual trunks representing communication between different components. In one example, components having self-loop edges are identified. When these components, hoses, and virtual trunks are identified, a method subtracts the corresponding entries from the traffic matrix to form a remainder traffic matrix for traffic that still remains to be modeled.

Further, defining, for the application, the TAG model based on the modified traffic matrix includes applying a trunk identification method to the traffic matrix to create sets of VMs having similar communication patterns to further define the TAG model. In one example, applying the trunk identification method to the traffic matrix to create the sets of VMs having the similar communication patterns includes identifying a set of VMs having the similar communication pattern and clustering the set of VMs having the similar communication pattern to a specific component to further define the TAG model. As a result, the sets of VMs having similar communication patterns to further define the TAG model may be clustered.

Defining, for the application, the TAG model based on the modified traffic matrix further includes merging a number of unassigned VMs to the number of cliques created by the hose identification method or to the sets of VMs created by the trunk identification method. At this point in the method, some VMs may remain unassigned because they are not part of any clique. For example, a virtual hose communication. However, the VMs may belong to other yet-identified components showing trunk communication patterns.

In one example, if any VMs remain unassigned, the method creates a new component, a specific component, or combinations thereof for each of the unassigned VMs. Further, the method creates virtual trunks modeling their traffic. Finally, the method considers merging the single-VM with each other or with the previously identified components. For each single-VM, the method considers the impact of merging the single-VM with other components. If doing so would not significantly decrease the number of virtual trunks, then the single-VM is not merged. Otherwise, the single-VM is merged with the component that would lead to the greatest reduction in the number of virtual trunks in the TAG model. For example, a component that would lead to the greatest reduction in the number of virtual trunks in the TAG model may be a new component, a specific component, previously identified components, or combinations thereof.

To find such components, the method identifies a set of VMs having a similar communication pattern. For example, a set of VMs with similar outgoing and incoming traffic and groups them together as a component. Two VMs have similar outgoing and incoming traffic if their corresponding rows and columns in the remainder traffic matrix have similar values in most entries. In one example, unsupervised learning clustering functions can be used to identify these sets. Once these sets are identified, the method clusters the set of VMs having the similar communication pattern to a specific component. For example, the method creates corresponding components and assigns the VMs to them, constructs virtual trunks between those components and subtracts their traffic from the remainder traffic matrix.

While this example has been described with reference to applying a hose identification method then a trunk identification method. The hose identification method and the trunk identification method may be applied at the same time. For example, in detecting cliques in the hose identification method, there may be a few links missing in the clique, and a small deviation can be tolerated and be able to identify a set of VMs showing similar communication patterns, though not forming a perfect clique. Such small deviations are tolerated in the trunk identification method by using unsupervised clustering techniques. However the hose function does not tolerate such small deviations. For example, consider a 50-node set with one link missing between VM one and VM two to form a clique. The hose identification method divides the entire set into two distinct components: [VM one, VM two], [the other VMs]. Because actual communication pattern in network datacenter may not follow a perfect clique pattern, it is desirable to ignore such small missing links and put all the VMs into one component.

Thus, as an alternative to executing the hose identification method and then the trunk identification method, the method executes the trunk identification method with some modification to the traffic matrix. The method starts by filling the diagonal entries of the original traffic matrix, to a certain value larger than the threshold parameter. Then, the rows and columns of VMs forming a clique will have non-zero values in the same set of entries indicating the traffic from/to the other VMs in the same clique. When there are a few links missing and the missing links are minor compared to the size of the network, unsupervised clustering identifies and clusters those VMs into the same clique.

In one example, other systems and methods may be used to create the TAG model. Once created, the placing system of FIG. 1 may obtain the TAG model. In this example, the TAG model is based on application communication structure and not the underlying physical network topology.

In one example, the TAG model may serve two purposes. First, the TAG model allows tenants to specify their network demands in a simple and intuitive yet accurate manner. Second, the TAG model is used to facilitate easy translation of the network demands and their efficient deployment on a low level infrastructure. As a result, the TAG model may be more accurate to model network demands than a hose model, a virtual oversubscribed cluster (VOC), a pipe model, other models, or combinations thereof.

As mentioned above, the method (700) includes determining (702) bandwidths for the components based on the TAG model. As mentioned above, the TAG model may include direct edges and self-looped edges. The direct edges and self-looped edges of the TAG model may be used to determine the bandwidths for the components based on the TAG model. In one example, the determining the bandwidths for the components based on the TAG model may include determining a sending bandwidth and a receiving bandwidth for each of the components. As a result, the sending bandwidth and the receiving bandwidth for each of the components are useful when the number of VMs of the two tiers is different.

In one example, the bandwidths may be in Mbps, Kbps, gigabits per second (Gbps), other measurements, or combinations thereof. As a result, a TAG model may be used to accurately model the bandwidths for each of the components.

As mentioned above, the method (700) includes placing (703) the VMs of the components on physical hardware based on the bandwidths for the components. In one example, placing the VMs of the components on physical hardware based on the bandwidths for the components aims to maximize network resource utilization by accepting as many tenant requests as possible while guaranteeing requested bandwidth.

In one example, placing the VMs of the components on the physical hardware based on the bandwidths for the components includes generating, from the TAG model, a list of components such as vertices, communication edges of the components, attributes of the components such as component size and bandwidth demand, or combinations thereof.

Further, placing the VMs of the components on the physical hardware based on the bandwidths for the components includes localizing communication patterns between the VMs of the components defined in the TAG model. In one example, the method (700) searches for a valid lowest-level sub-tree under which the entire TAG model is likely to fit. The method (700) searches from the server level and moves upwards. For example, the method (700) searches from the server level, then an aggregated switch level, then a network switch level, then a root to node level. In one example, the TAG model's demand for slots for VMs and bandwidth for communication with external entities are validated against the total number of slots for VMs that are available in the server under the valid lowest-level sub-tree and the available uplink bandwidth from the valid lowest-level sub-tree to the tree root.

In one example, the method (700) may fail to allocate the entire TAG model under valid lowest-level sub-tree because the bandwidth availability of the links below the valid lowest-level sub-tree is not guaranteed. Further, the actual demand on those links are unknown until the exact number of VMs of each tier that is to be placed under each sub-tree under the valid lowest-level sub-tree is known.

Further, the method (700) prevents repeated attempts to deploy the same TAG model on previously tried but failed sub-trees. By doing this, the method's speed may be increased.

Further, placing the VMs of the components on the physical hardware based on the bandwidths for the components includes mapping locations where the VMs are to be allocated on the physical hardware and bandwidths of the VMs. For example, the method (700) attempts to deploy the TAG model on the valid lowest-level sub-tree by calling an Alloc function. The Alloc function returns a map of allocated VMs and their server location and reserves slot and bandwidth in the sub-tree below the valid lowest-level sub-tree.

In one example, if the map covers all the VMs of the TAG model, the method's Alloc function successfully returns after reserving slot and bandwidth resources from the valid lowest-level sub-tree up to the root. Further, a provider may launch the VMs on the specified server according to the map. For example, method's Alloc function first checks if the target sub-tree, such as the valid lowest-level sub-tree, is a server. If the target sub-tree is a server, the method's Alloc function allocates the TAG model's VMs on the server and returns. In this example, the method (700) assumes available bandwidth is always available for communication between VMs on the same server.

However, if the method's Alloc function fails to deploy the entire TAG model the method's Dealloc function releases the resources reserved for the VMs in the map. The method (700) then repeatedly tries to allocate the TAG model under a new sub-tree at the valid lowest-level sub-tree's parent level until it fails at the tree root.

In one example, mapping the locations where the VMs are to be allocated on the physical hardware and the bandwidths of the VMs includes performing a Colocate function, a Balance function, or combinations thereof. For example, if the valid lowest-level sub-tree is a ToR or higher level switch, the method's Alloc function strategically allocates the TAG model's VMs over the valid lowest-level sub-tree's child nodes by the Colocate function and/or Balance function. In one example, the method's Alloc function is a recursive function that is invoked by the Colocate and/or Balance function.

In one example, the Colocate function groups the VMs close together on the physical hardware to reduce traffic between the VMs for bandwidth saving. For example, the Colocate function is invoked when bandwidth saving through colocation is feasible. As a result, the functionality of the Colocate function is to determine the semi-optimal set of components and their VMs to collocate.

In one example, bandwidth saving through colocation may be feasible when the number of VMs of a component that reside in a sub-tree is greater than the total number VMs of the component. For example, as the method (700) recurses down the tree by subsequent invocations of the method's Alloc function, the number of VMs of a hose tier, or a pair to trunk tiers, in the TAG model may become less than fifty percent of the original tier size. This can result in bandwidth saving becoming infeasible.

In another example, bandwidth saving through colocation may be determined by HA demands. In one example, a HA engine may be used determine criteria for HA. The HA engine may include a user interface to allow a user to input criteria for HA. In another example, the HA engine may use the TAG model to determine criteria for HA. Further, other methods and techniques may be used to determine criteria for HA. Once, the criteria for HA is determined, it may be received by, for example, the placing system of FIG. 1. In one example, if ant-affinity is utilized at a certain tree level with fifty percent or higher worst case survivability (WCS), it is impossible to place more than fifty percent of a tier under that certain tree level. More information about the HA will be described later on in this specification.

In one example, the colocation function may further remove low-bandwidth tiers form a subset of the TAG model that can be placed together with high bandwidth tiers as seen in FIG. 6. The method (700) identifies tiers having low per-VM bandwidth demands when compared to the per-slot available bandwidth of the valid lowest-level sub-tree's child nodes. As will be described below, these tiers, to achieve balanced resource utilization, can be placed together with higher bandwidth demanding tiers that cannot be collocated by themselves as shown In FIG. 6.

The Balance function determines utilization of compute resources, network resources, or combinations thereof. Further, the Balance function determines a set of VMs from different components to place together on the physical hardware to achieve a balanced utilization of resources. For example, to achieve balance of slot and bandwidth utilization, the Balance function is invoked to deploy the VMs remaining in the TAG model after the colocation function is invoked. In this example, the Balance function is invoked when bandwidth saving in infeasible or unwanted.

In one example, for a selected child node, the Balance function tries to find the best set of VMs that will lead to both slot and uplink utilization of the child node to approach one-hundred percent or equal slot and uplink utilization. The goal of the Balance function is to take advantage of all the compute resources and network resources to maximize the workload of the network. In one example, to improve the Balance function's speed, the method (700) iterates over the tiers in the TAG model instead of every VM because the VMs in the same tier have the same resource demands. As a result, the main goals of the Colocate function and the balance function are to determine the sets of VMs to place on physical hardware based on each respective optimization goals. As a result, these functions reduce bandwidth consumption and balance resource utilization.

Further, placing the VMs of the components on the physical hardware based on the bandwidths for the components further includes providing HA and predictable performance for communication patterns for the VMs. In one example, HA may include meeting an anti-affinity goal and an opportunistic anti-affinity goal.

Guaranteeing network bandwidth for predictable performance and HA are both first class goals for many applications. An HA demand can be expressed as anti-affinity or anti-colocation. For example, the VMs of the same tier/service must reside on different servers to ensure that the application does not suffer downtime if a single server fails. Often, most network providers tend to deploy fault-resilient networking, especially at higher level switches, but there is no such mechanism for server failures. Thus, anti-affinity is more desired at servers to increase WCS. To guarantee anti-affinity, the method (700) sets an upper bound for the number of VMs placed on a sub-tree of a certain level, such as a server level or a higher level. When anti-affinity is required at level X, the same upper bound is applied also to levels lower than X.

In one example, guaranteeing WCS tends to decrease datacenter utilization. For tiers without HA guarantees, the method (700) opportunistically distributes VMs across servers if bandwidth saving is infeasible or deemed undesirable. In one example, bandwidth saving is less crucial at the server level where anti-affinity is most helpful for HA. The method (700) determines bandwidth saving desirability by comparing the bandwidth-to-slot ratio of available unallocated resources under the lowest level valid sub-tree against the average per-VM bandwidth demand of the TAG model. This may be done by factoring in the expected contributions of future tenant VMs based on previous arrivals. If the former is smaller than the latter, bandwidth saving is deemed desirable.

To implement the opportunistic anti-affinity goal, the Colocate function is invoked only when it is both feasible and desirable. Similarly, method (700) starts searching from the lowest level where bandwidth saving is desirable, instead of blindly starting from the server level. The method (700) may further return only one VM in a subset of the TAG model and to select the best child for that VM when bandwidth saving is not desirable. This leads to distributed VM allocations over multiple child nodes while still achieving balanced slot and bandwidth utilization of the child nodes. When bandwidth saving is desirable, method (700) continues to fill in one child node at a time, thus leaving more child nodes with more slots available for future tenants. As a result, the opportunistic anti-affinity goal can greatly improve average WCS at the cost of marginally decreased network utilization while preserving all bandwidth guarantees. The decrease is due to the imperfect estimation of future demands and thus suboptimal desirability decision.

While this example has been described with reference to using a TAG model to place VMs on physical hardware to guarantee bandwidth, other network models may be used to place VMs on physical hardware to guarantee bandwidth. For example, a hose model, a virtual oversubscribed cluster model, or other network models may be used to place VMs on physical hardware to guarantee bandwidth.

FIG. 8 is a flowchart of an example of a method for placing VMs on physical hardware to guarantee bandwidth, according to one example of principles described herein. In one example, the method (800) may be executed by the system (100) of FIG. 1. In other examples, the method (800) may be executed by other systems such as system 900 or system 1000. In this example, the method (800) includes obtaining (801) a TAG model, the TAG model representing a network abstraction model based on an application communication structure between VMs of components, determining (802) bandwidths for the components based on the TAG model, placing (803) the VMs of the components on physical hardware based on the bandwidths for the components, and enforcing (804) the bandwidths of the components based on communication patterns between the VMs of the components.

As mentioned above, the method (800) includes enforcing (804) the bandwidths of the components based on communication patterns between the VMs of the components. In one example, a scalable runtime mechanism may be used to enforce the bandwidth and utilize unused bandwidth efficiently.

In another example, common techniques and methods may be used to enforce the bandwidths of the components based on the communication patterns between the VMs of the components. For example, the common techniques and methods may be adapted for models such as a hose model, a VOC, a pipe model, other models, or combinations thereof. As a result, the common techniques and methods may be modified to accommodate the TAG model.

FIG. 9 is a diagram of an example of a placing system, according to one example of principles described herein. The placing system (900) includes an obtaining engine (902), a determining engine (904), and a placing engine (906). In this example, the placing system (900) also includes an enforcing engine (908). The engines (902, 904, 906, 908) refer to a combination of hardware and program instructions to perform a designated function. Each of the engines (902, 904, 906, 908) may include a processor and memory. The program instructions are stored in the memory and cause the processor to execute the designated function of the engine.

The obtaining engine (902) obtains a TAG model, the TAG model representing a network abstraction model based on an application communication structure between VMs of components. In one example, the obtaining engine (902) obtains one TAG model. In another example, the obtaining engine (902) obtains several TAG models.

The determining engine (904) determines bandwidths for the components based on the TAG model. In one example, the determining engine (904) determines a sending bandwidth and a receiving bandwidth for each of the components.

The placing engine (906) places the VMs of the components on physical hardware based on the bandwidths for the components. In one example, the placing engine (906) places the VMs of the components on the physical hardware based on the bandwidths for the components by generating, from the TAG model, a list of components, communication edges of the components, attributes of the components, or combinations thereof, localizing communication patterns between the VMs of the components defined in the TAG model, and mapping locations where the VMs are to be allocated on the physical hardware and bandwidths of the VMs.

In one example, mapping the locations where the VMs are to be allocated on the physical hardware and the bandwidths of the VMs includes performing a Colocate function, a Balance function, or combinations thereof. In one example, the Colocate function groups the VMs close together on the physical hardware to reduce traffic between the VMs for bandwidth saving. Further, the Balance function determines utilization of compute resources, network resources, or combinations thereof. Further, the placing engine (906) places the VMs of the components on the physical hardware based on the bandwidths for the components to provide HA and predictable performance for communication patterns for the VMs.

The enforcing engine (908) enforces the bandwidths of the components based on communication patterns between the VMs of the components. In one example, the enforcing engine (908) enforces the sending and receiving bandwidths of the components.

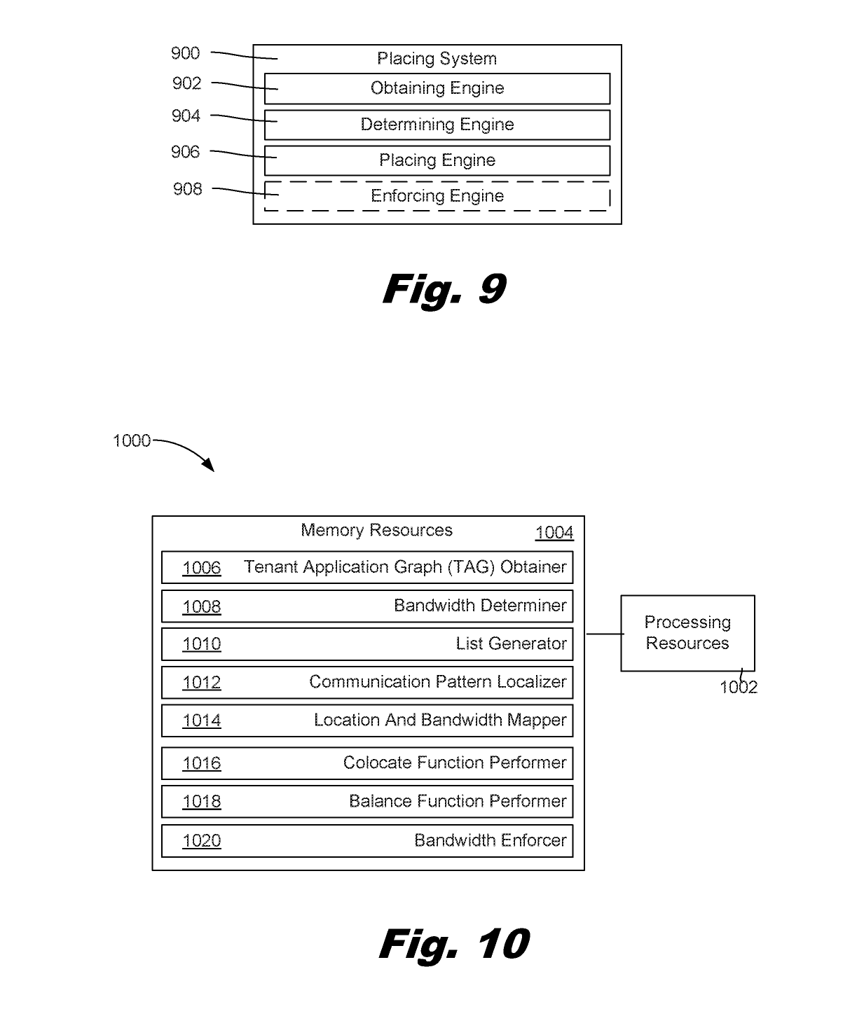

FIG. 10 is a diagram of an example of a placing system (1000), according to one example of principles described herein. In this example, placing system (1000) includes processing resources (1002) that are in communication with memory resources (1004). Processing resources (1002) include at least one processor and other resources used to process programmed instructions. The memory resources (1004) represent generally any memory capable of storing data such as programmed instructions or data structures used by the placing system (1000). The programmed instructions shown stored in the memory resources (1004) include a TAG obtainer (1006), a bandwidth determiner (1008), a list generator (1010), a communication pattern localizer (1012), a location and bandwidth mapper (1014), a Colocate function performer (1016), a Balance function performer (1018), and a bandwidth enforcer (1020).

The memory resources (1004) include a computer readable storage medium that contains computer readable program code to cause tasks to be executed by the processing resources (1002). The computer readable storage medium may be tangible and/or physical storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, or types of memory, or combinations thereof.

The TAG obtainer (1006) represents programmed instructions that, when executed, cause the processing resources (1002) to obtain a TAG model, the TAG model representing a network abstraction model based on an application communication structure between VMs of components. The bandwidth determiner (1008) represents programmed instructions that, when executed, cause the processing resources (1002) to determine bandwidths for the components based on the TAG model.

The list generator (1010) represents programmed instructions that, when executed, cause the processing resources (1002) to generate, from the TAG model, a list of components, communication edges of the components, attributes of the components, or combinations thereof. The communication pattern localizer (1012) represents programmed instructions that, when executed, cause the processing resources (1002) to localize communication patterns between the VMs of the components defined in the TAG model.

The location and bandwidth mapper (1014) represents programmed instructions that, when executed, cause the processing resources (1002) to map locations where the VMs are to be allocated on the physical hardware and bandwidths of the VMs. The Colocate function performer (1016) represents programmed instructions that, when executed, cause the processing resources (1002) to perform a Colocate function, in which the Colocate function groups the VMs close together on the physical hardware to reduce traffic between the VMs for bandwidth saving.

The Balance function performer (1018) represents programmed instructions that, when executed, cause the processing resources (1002) to perform a balance function to determine utilization of compute resources, network resources, or combinations thereof. The bandwidth enforcer (1020) represents programmed instructions that, when executed, cause the processing resources (1002) to enforce the bandwidths of the components based on communication patterns between the VMs of the components.

Further, the memory resources (1004) may be part of an installation package. In response to installing the installation package, the programmed instructions of the memory resources (1004) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (1002) and the memory resources (1002) are located within the same physical component, such as a server, or a network component. The memory resources (1004) may be part of the physical component's main memory, caches, registers, non-volatile memory, or elsewhere in the physical component's memory hierarchy. Alternatively, the memory resources (1004) may be in communication with the processing resources (1002) over a network. Further, the data structures, such as the libraries, may be accessed from a remote location over a network connection while the programmed instructions are located locally. Thus, the placing system (1000) may be implemented on a user device, on a server, on a collection of servers, or combinations thereof.

The placing system (1000) of FIG. 10 may be part of a general purpose computer. However, in alternative examples, the placing system (1000) is part of an application specific integrated circuit.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method for placing virtual machines (VMs) on physical hardware to guarantee bandwidth, the method comprising:
obtaining a Tenant Application Graph (TAG) model, the TAG model representing a network abstraction model based on an application communication structure between VMs of components;
determining bandwidths for the components based on the TAG model; and
placing the VMs of the components on physical hardware based on the bandwidths for the components.

2. The method of claim 1, in which determining the bandwidths for the components based on the TAG model comprises determining a sending bandwidth and a receiving bandwidth for each of the components.

3. The method of claim 1, in which placing the VMs of the components on the physical hardware based on the bandwidths for the components further comprises providing high availability (HA) and predictable performance for communication patterns for the VMs.

4. The method of claim 1, in which placing the VMs of the components on the physical hardware based on the bandwidths for the components comprises:
generating, from the TAG model, a list of components, communication edges of the components, attributes of the components, or combinations thereof;
localizing communication patterns between the VMs of the components defined in the TAG model; and
mapping locations where the VMs are to be allocated on the physical hardware and bandwidths of the VMs.

5. The method of claim 4, in which mapping the locations where the VMs are to be allocated on the physical hardware and the bandwidths of the VMs comprises performing a Colocate function, a Balance function, or combinations thereof.

6. The method of claim 5, in which the Colocate function groups the VMs close together on the physical hardware to reduce traffic between the VMs for bandwidth saving.

7. The method of claim 5, in which the Balance function determines utilization of compute resources, network resources, or combinations thereof and determines a set of the VMs from different components to place together on the physical hardware to achieve a balanced utilization of resources.

8. The method of claim 1, further comprising enforcing the bandwidths of the components based on communication patterns between the VMs of the components.

9. A system for placing virtual machines (VMs) on physical hardware to guarantee bandwidth, the system comprising:
an obtaining engine to obtain a Tenant Application Graph (TAG) model, the TAG model representing a network abstraction model based on an application communication structure between VMs of components;
a determining engine to determine bandwidths for the components based on the TAG model;
a placing engine to place the VMs of the components on physical hardware based on the bandwidths for the components; and
an enforcing engine to enforce the bandwidths of the components based on communication patterns between the VMs of the components.

10. The system of claim 9, in which the placing engine further provides high availability (HA) and predictable performance for communication patterns for the VMs.

11. The system of claim 9, in which the placing engine places the VMs of the components on the physical hardware based on the bandwidths for the components by:
generating, from the TAG model, a list of components, communication edges of the components, attributes of the components, or combinations thereof;
localizing communication patterns between the VMs of the components defined in the TAG model; and
mapping locations where the VMs are to be allocated on the physical hardware and bandwidths of the VMs.

12. The system of claim 11, in which mapping the locations where the VMs are to be allocated on the physical hardware and the bandwidths of the VMs comprises performing a Colocate function, a Balance function, or combinations thereof;
in which the Colocate function groups the VMs close together on the physical hardware to reduce traffic between the VMs for bandwidth saving; and
in which the Balance function determines utilization of compute resources, network resources, or combinations thereof and determines a set of the VMs from different components to place together on the physical hardware to achieve a balanced utilization of resources.

13. A computer program product for placing virtual machines (VMs) on physical hardware to guarantee bandwidth, comprising:
a tangible computer readable storage medium, said tangible computer readable storage medium comprising computer readable program code embodied therewith, said computer readable program code comprising program instructions that, when executed, causes a processor to:
determine bandwidths for components based on a Tenant Application Graph (TAG) model;
place VMs of the components on physical hardware based on the bandwidths for the components; and
enforce the bandwidths of the components based on communication patterns between the VMs of the components.

14. The product of claim 13, further comprising computer readable program code comprising program instructions that, when executed, cause said processor to obtain the TAG model, the TAG model representing a network abstraction model based on an application communication structure between the VMs of the components.

15. The product of claim 13, further comprising computer readable program code comprising program instructions that, when executed, cause said processor to provide high availability (HA) and predictable performance for communication patterns for the VMs.
